(19) United States
(12) Patent Application Publication
(10) Pub. No.: US 2025/0102411 A1
(43) Pub. Date: Mar. 27, 2025

(54) SYSTEM AND METHOD FOR CALCULATING SHEAR STRESS OF DRILLING FLUIDS WITHOUT USING VISCOMETER DATA

(71) Applicant: Milap GOUD, Andheri East Mumbai (IN)

(72) Inventor: Milap GOUD, Andheri East Mumbai (IN)

(21) Appl. No.: 18/534,116

(22) Filed: Dec. 8, 2023

(30) Foreign Application Priority Data
Sep. 27, 2023 (IN) 202321064806

(51) Int. Cl. G01N 11/14

(52) U.S. Cl. CPC G01N 11/14

(57) ABSTRACT

A system and a method for calculation of a shear stress at any given shear rate for an aqueous and a non-aqueous mud separately at bottom hole conditions without using rotational viscometer data. The system includes one or more sensors to identify drilling parameters, and three key modules namely for calculating data constants, selecting shear rate, and calculating shear stress. The disclosed system and method significantly enhances the control and management of drilling fluids. The system's effectiveness is demonstrated through the encompassing of a wide spectrum of real-time drilling conditions, including fluid type, temperature, mud composition, and more. Employing specific formula constants for each mud type and accommodating varying shear rates, the system ensures precise calculations. Overall, this system is poised to revolutionize drilling fluid management and analysis.

### CROSS-REFERENCE TO RELATED APPLICATIONS AND PRIORITY

The present application does claim priority from Indian Patent Application number 202321064806 filed on 27 Sep. 2023.

### FIELD OF INVENTION

The present invention relates to a field of a drilling of oil and gas wells. More specifically, the present disclosure relates to calculation of shear stress at any given shear rate for an aqueous and a non-aqueous mud separately at bottom hole conditions without using rotational viscometer data.

### BACKGROUND OF THE INVENTION

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Conventionally, the drilling of oil and gas wells rely on drilling fluids to serve several critical functions. These include, lifting the rock cuttings to surface, maintaining the necessary hydrostatic head of open on the walls of a wellbore and to safeguard the wellbore from the possible damage caused by mechanical and chemical forces resulting in destabilization of rock with time, cooling the drilling process/environment by dissipating heat during the drilling by virtue of being a good conductor of heat, and providing a medium for transmitting electrical signals for studying the rock properties, and many other.

One of the most important functions of drilling fluid (also termed as mud interchangeably) is to bring the cuttings to surface, which is attributed to mud by two properties, namely mud weight and rheology. Mud weight although, has a role to play in removing the cuttings out of hole, but it has got other more important role of exerting the correct hydrostatic pressure on the rock and hence, it cannot be altered, only to change cuttings removal efficiency. Thus, rheology attains the highest importance in drilling fluids management when we focus on cuttings removal.

The basic structural difference between the two most popularly used types of drilling fluid, namely aqueous or non-aqueous, has an impact on their rheological behaviour. Although many in industry were aware about this, but for the lack of complex mathematical tools in those days, the issue did not get due attention. With the passage of time, the professionals got comfortable with the measurements, despite knowing the inherent fallacy, simply because during drilling, it is in fact the relative change in rheology which attains more importance than the absolute value of rheology. Thus, a sort of comfort zone prevailed in industry, which got exposed while we started drilling more and more wells in HTHP and Deep-water environment, where the extreme temperature and pressure variations started posing problems in managing the rheology of both the types of mud, when they were measured without any distinction, by offering similar treatment, despite being structurally in sharp contrast with each other to the extent that the measurements became arbitrary and started adversely affecting the drilling fluids management.

The aqueous drilling fluid inherits the rheological feature and non-Newtonian behaviour by a property called “Thixotropy”, arising as a result of electrostatic forces of attraction between oppositely charged ions of Hydrophilic clay and water molecules, leading to convergence of layers of clay during static condition of mud, arising out of period of “No circulation”, and dispersion during circulation of mud due to application of external force in the form of pump pressure—a situation in drilling campaign which occurs commonly and intermittently. Thus, the Aqueous mud converts into a gelled but soft fluid in static condition, which will reconvert into a free-flowing fluid when an external force (shear stress) is applied on it. This conversion of Gel to fluid state of mud, popularly described as “Gel-sol”, is also referred as the shear thinning behaviour of mud and it helps to suspend the cuttings into gelled structure of mud during static condition. Subsequently, upon application of external force, (Shear-stress) the fluid starts flowing freely.

The non-Aqueous mud also exhibits similar behaviour of “shear thinning” leading to its acquisition of non-Newtonian feature, same as in Aqueous mud. Therefore, when non-Aqueous mud came in existence, (much later than Aqueous mud) the industry simply borrowed the concept of Rheological models proposed for Aqueous mud straightaway, without accounting for difference in mechanism of acquisition of Rheological feature in both the types of mud, which were radically different than each other. The non-Aqueous mud exhibits non-Newtonian behaviour by virtue of “Visco-elasticity” attributed to dissolution of Organophilic clay in base oil, leading to increase in intrinsic viscosity of the emulsion of brine and the base oil, that forms the skeleton of non-Aqueous mud, popularly termed as “pre-mix”. Although the non-Polar base oil and organophilic clay become miscible with each other to impart additional viscosity to the liquid emulsion phase of non-aqueous mud, there are no forces of attraction between base oil and clay due to absence of charge-charge interaction. Thus, the extent of non-Newtonian feature displayed by two structurally different mud systems will vary to the extent that they require separate rheological models to characterise their flow patterns in the real bottom-hole conditions.

However, conventionally, during drilling operations, viscometric measurements play a vital role in assessing the rheology of drilling fluids for efficient fluid management. The industry professionals follow the viscometer-measured values that help them assess the fluid's rheology, which is essential for maintaining efficient drilling. However, there are limitations to this approach. Viscometers provide data under controlled laboratory conditions, which may not fully represent the dynamic and variable conditions encountered in a real drilling environment. Additionally, they may not account for the effects of temperature, pressure, and shear rate fluctuations that occur downhole.

Traditionally, the industry had been measuring the rheology of drilling fluid in laboratory with the help of a rotational viscometer, where the measuring environment is different than the environment of borehole, in which the fluid travels. Although over a period of time, the laboratory and the measuring equipment have evolved and are able to mimic some conditions of the hole, but yet the majority of the conditions are still different than actual borehole conditions. This deviation along with following other shortcomings, makes the measurement/s unrealistic. Followings are the shortcomings of the traditional way of using the laboratory and measuring equipment for analysing the shear stress as:

### Memory Retention

The rotational viscometer inherently suffers from memory retention that adversely affects the overall accuracy level of the measurements made. It becomes clear with following description. If a fluid whose rheology is measured, is too thick and the next fluid to follow for measurement happens to be too thin, then the rheological values of measured “thin” fluid will be sensed by rotational viscometer marginally higher, because of the impact of previous “thick” fluid. Likewise, if the previous fluid was very thin and the fluid to follow is very thick then the measured values of “thick” fluid will be marginally lower, an inherent trait of rheology measurement/s.

### Anomalous Temperature of Drilling Fluid/s

Although both the non-Aqueous and Aqueous types of mud will expand thermally as the temperature increases, but the magnitude of expansion is exponentially higher in non-Aqueous mud. This drastically reduces the rheology of non-Aqueous mud with increasing temperature to a level that provides a passage for the error to creep in Rheological measurements which cannot be overlooked. On the contrary the minor decrease in rheology of Aqueous mud gets addressed by itself since the water phase of Aqueous mud will start evaporating at temperature beyond 100 deg C., the boiling point of water. As water gets expelled from mud at temperatures >100 deg C., the resultant net solid content of mud will increase. It will result in increased rheology of Aqueous mud. However, in non-Aqueous mud such behaviour is not observed because non-Aqueous emulsion does not boil even if the temperature crosses beyond 100 deg C. The emulsion phase remains stable at any prevailing higher value of temperature and non-Aqueous mud will continuously keep losing the rheology in direct proportion to increase in temperature. The strikingly different behaviour of both the mud systems is not adequately addressed in the current method of measurements of rheology, thereby calling for a realistic revision in acquiring the rheological data to make the values more meaningful and realistic at actual conditions of drilling, which is missing in measurement of rheology by rotational viscometer. To sum up, we can conclude that in Aqueous mud, the rheology of mud will initially decrease to a small extent but will keep increasing, once the bottom-hole temperature crosses 100 deg C. or the boiling point of mud, whereas in case of non-Aqueous mud the rheology will continuously keep decreasing exponentially as temperature keeps increasing. The exact temperature at which the aqueous fluid will shed water in the form of vapour from itself depends upon composition, mainly the total corrected solids present. This is due to the phenomena of elevation in boiling point. Higher the solid content, higher is the boiling point.

### Measurement and Calibration Related Errors

The values of Plastic Viscosity (PV) and Yield Point (YP) obtained on the basis of measuring 600 and 300 RPM reading is by reading the value of shear stress on the scale and this observation, although simple, but has a room for personal judgmental error of accurately reading the scale. In addition to it, the entire dependence of rheological properties is on the calibration of equipment which has a potential to adversely affect the measured values. Those who work in field will immediately correlate with this feature, and an element of uncertainty prevails regarding the status of the equipment and the equipment can go out of calibration any time, without giving any visible indications. Regular use of equipment can, at times, disrupt the calibration. Although there is a periodic maintenance plan for equipment but theoretically speaking, the equipment can go out of calibration range even before it is due for calibration, and we will not even be able to know that.

### Flow Pattern of Fluid in Hole and During Measurement are Different

The fluid travels up against the gravity in real annulus where-as the fluid experiences a concentric circular motion in the equipment while making the measurements. The difference in the way the fluid moves, can make the difference. Although one can say that the fluid in annulus also moves spirally during pipe-rotation, but pipe rotation is not a regular feature of drilling and at times we purposely do not rotate the pipe for operational reasons.

### Measurement of Rheology is Carried Out Only at Fixed & Preset RPM

The industry has accepted the concept of measuring the rheology at fixed RPM without anyone ever questioning the rationale behind it. The invention retains the available benefit and in fact it provides an alternative option of calculating the shear stress at any shear rate and utilize the data for better management of drilling fluids.

### Design Limitation Due to the Lower/Upper Range Ability of the Equipment

At times the equipment is incapable of measuring the values due to its limitation in design where-in, it cannot measure shear stress, if the value is beyond chosen maximum range of 600 RPM. Most of the rotational viscometers have the highest RPM of 600 to measure the shear stress of the fluid, where-as it is still unclear as to what is the correct RPM that can resonate with hole conditions which keep changing as the fluid travels up in the annulus.

### Variation in Hydraulic Diameter

The annulus size keeps varying during drilling, but measurements are always made at fixed gap between the rotor and stator of the equipment. In laboratory the fluid Is always subjected to a fixed gap between the rotor and the stator where-as in real situation the fluid passes through different diameters, and that adds to the uncertainty of gap between measurement and the actual rheological property of the fluid.

### Measurement Pattern

Rheological measurements in equipment are carried out from high to low RPM where-as in actual field conditions when a fluid flow is initiated the shear rate starts from lower to higher value.

### The Type of Fluid

Whether we use aqueous or non-Aqueous fluid, the measuring equipment doesn't distinguish and treats both the fluids same where-as realistically both fluids experience quite different flow-pattern which goes unnoticed in the measurements we make.

### Presence of Cuttings in the Hole

Presence of cuttings impacts the overall hole-cleaning, but shear stress measurement of drilling fluid is measured in a cuttings-free sample in the equipment.

These shortcomings were recognized by the industry. However, in rheological measurements, if the error is constant on all occasions, then the impact of the error gets negated and in the absence of any better alternative, the status-quo prevailed with the process of measuring the relative rheology and focusing on the change in rheology. As time progressed, the anomaly became more evident with the invention of non-Aqueous drilling fluid, because many times, the temperature-triggered expansion of non-Aqueous drilling fluid is conspicuously too high in magnitude to be neglected. Another fallacy that crept in the rheological measurements of non-Aqueous fluid is due to the fact that non-Aqueous drilling fluid imparts rheology due to visco-elasticity of the fluid where-as aqueous fluid imparts rheology due to thixotropy of the fluid. All these aberrations led to several modifications in the models of rheology, away from the original Bingam plastic model. However. the improvement in prediction of flow pattern of the fluid has not only been a slow process, but also circumvented around factors other than real borehole conditions' inclusion, for the simple reason that there was no specific way to resolve it.

Therefore, while viscometers offer valuable insights, they should be supplemented with real-time downhole calculations for a comprehensive understanding of drilling fluid behaviour.

Thus, there has been a long-felt need for overcoming the shortcomings of the laboratory measurements of the rheology by real-time calculations of shear stress under actual bottom-hole conditions in the field, without using lab operated rotational viscometers, for aqueous or non-aqueous mud separately.

### SUMMARY OF THE INVENTION

The present disclosure overcomes one or more shortcomings of the prior art and provides additional advantages discussed throughout the present disclosure. Additional features and advantages are realized through the techniques of the present disclosure. This summary is not intended to identify the essential features of the claimed subject matter nor is it intended for use in determining or limiting the scope of the claimed subject matter.

The present disclosure has been made in order to solve the problems, and it is an object of the present disclosure to overcome all the short-comings and enable calculation of shear stress at any given shear rate under real-time bottom-hole conditions in the drilling field. The present disclosure aids in eliminating any error/s and ambiguities related to the use of rotating viscometers, as well as relieving the field engineers of the obligation of using them.

In one implementation of the present disclosure, a system to calculate shear stress under bottom hole drilling conditions for both an aqueous and a non-aqueous mud, eliminating the need for rotational viscometer data, is disclosed. It operates using a combination of sensors and variables to detect relevant drilling condition parameters, a first module for receiving a data constant, and a second module for selecting a shear rate. The core function lies in a third module, which computes the shear stress independently for the aqueous and the non-aqueous mud. This system offers a more versatile and accurate means of shear stress determination in real-time drilling scenarios, enhancing drilling fluid management and control.

In one embodiment of the present disclosure, a system for calculating the shear stress at any given shear rate for an aqueous and a non-aqueous mud separately, at bottom hole drilling conditions (101) without using rotational viscometer data, is disclosed. The system may comprise one or more sensors to identify the real-time bottom hole drilling conditions/parameters, which may include parameters like fluid type (aqueous or non-aqueous), hole depth affecting flow pattern, real-time temperature (Bottom hole circulation temperature), hydraulic diameter impacting the flow path, operating range (lower range or upper range), annular velocity, mud composition, solids percentage in mud (also termed as ‘corrected solids’ interchangeably), emulsion density, water and oil content, oil-to-water ratio, and clay content of mud. Further, the system may comprise a first module for receiving one or more data constants. The one or more data constants may be utilized for identifying non-quantifiable parameters affecting the calculation of shear stress. In one embodiment, the one or more data constants may correspond to cutting size, cutting shape, hole tortuosity, fluid lubricity, fanning friction factor, and static state duration of mud during operations. Further, the system may comprise a second module for selecting a shear rate. The currently prevailing shear rates 600 RPM, 300 RPM, 200 RPM, 100 RPM, 60 RPM, 30 RPM, 6 RPM, and 3 RPM form the basis of devising the formula, only to begin with. Furthermore, the system may comprise of a third module for calculating the shear stress for the selected shear rate by using the one or more data constants and the one or more parameters of bottom hole drilling conditions identified by the one or more sensors. In one embodiment, the third module may comprise a first sub-module and a second sub-module. The first sub-module may be configured to calculate shear stress for the aqueous mud. The second sub-module may be configured to calculate shear stress for the non-aqueous mud. These calculations rely on specific formula constants, derived differently for each type of mud. For the aqueous mud, the data constant is determined using a formula involving parameters like hydraulic diameter, solids content, clay content, annular velocity, bottom hole circulating temperature, oil percentage, and corrected solids. The shear stress in aqueous mud is then computed with a shear stress formula involving data constant for the aqueous mud. Similarly, for the non-aqueous mud, a distinct data constant is calculated using a formula incorporating factors like hydraulic diameter, corrected solids, emulsion density, water percentage, clay content, annular velocity, bottom hole circulating temperature, oil percentage, and the oil-to-water ratio. The shear stress for the non-aqueous mud is determined using another shear stress formula involving data constant for the non-aqueous mud. In one embodiment, the system may employ a multivariate linear regression model within the third module for calculation of the shear stress and more advanced analysis.

In another implementation of the present disclosure, a method introduces an innovative way to calculate shear stress under bottom hole drilling conditions for both an aqueous and a non-aqueous mud, bypassing the need for rotational viscometer data. The method involves multiple stages. Initially, bottom hole drilling condition parameters are detected using one or more sensors. Subsequently, a first module may be used to receive one or more data constants, while a second module may be used to selects a shear rate. The crux of the methodology lies within a third module, which utilizes the received data constants and identified drilling condition parameters to calculate shear stress separately for the aqueous and the non-aqueous mud. This inventive approach offers a comprehensive means of shear stress determination in real-world drilling scenarios, enhancing drilling fluid management and overall control.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a block diagram describing a system (100) for the calculation of a shear stress at any given shear rate without using rotational viscometer data, in accordance with an embodiment of a present subject matter;

FIG. 2 illustrates a diagram showing an overview of a server system (200) for calculation of the shear stress at any given shear rate without using rotational viscometer data, in accordance with an embodiment of a present subject matter; and

FIG. 3 illustrates a flowchart describing a method (300) for calculating the shear stress at any given shear rate without using rotational viscometer data, in accordance with an embodiment of the present subject matter.

### DETAILED DESCRIPTION OF THE INVENTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

The conventional drilling of oil and gas process involves rotating a drill bit with axial force provided by surface equipment, like a drilling rig. A drill pipe connects the bit and provides a hydraulic passage through which drilling fluid is pumped. The drilling fluid, also known as drilling mud, pumped through the drill pipe helps to cool the drill bit and carry rock cuttings out of the wellbore while drilling. This fluid plays a crucial role in lubricating, stabilizing, and maintaining pressure within the wellbore to prevent collapses and ensure smooth drilling operations.

Herein, the shear stress and shear rate are crucial parameters used in assessing the hole-cleaning efficiency in drilling operations. The shear stress measures the force exerted on the drilling fluid, while shear rate quantifies the rate at which adjacent fluid layers move relative to each other. In wellbore cleaning, the balance between these two factors is vital. Adequate shear stress is needed to transport drilled cuttings and debris to the surface efficiently. Simultaneously, the shear rate must be managed to prevent excessive wear and tear on drilling equipment. Finding the right balance between shear stress and shear rate ensures optimal wellbore cleaning, preventing blockages and maintaining drilling efficiency.

In the light of the above-mentioned objectives, the present disclosure provides a system and a method for realistic assessment of the bottom-hole conditions of the wellbore, that facilitates the calculation of a shear stress at any given shear rate for an aqueous and a non-aqueous mud separately without using rotational viscometer data. This serves as a preventive step to keep the wellbore healthy, stable and in-gauge.

In one non-limiting embodiment, the system to calculate the shear stress under bottom hole drilling conditions for both an aqueous and a non-aqueous mud, eliminating the need for rotational viscometer data, is disclosed. It operates using a combination of one or more sensors/variable, but monitored parameters to detect relevant drilling condition, a module for receiving a data constant, and another module for selecting a shear rate. The core function lies in a yet another module, which computes the shear stress independently for the aqueous and the non-aqueous mud. This system offers a more versatile and accurate means of shear stress determination in real-time drilling scenarios, enhancing the level of drilling fluid management and control.

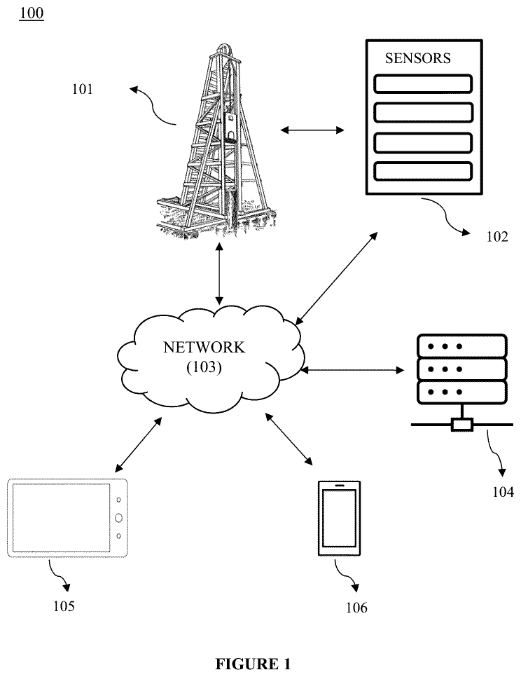

Now, referring to FIG. 1, a block diagram describing a system (100) for calculation of the shear stress at any given shear rate without using rotational viscometer data, is illustrated in accordance with an embodiment of a present subject matter. The system (100) includes a wellbore, working under real-time bottom-hole drilling environment (101), coupled with one or more sensors (102). The system (100) further includes a server (104) connected with the bottom-hole drilling environment (101) and the one or more sensors (102) via a communication network (103). In an embodiment of the present disclosure, the system (100) may include one or more user device (105, 106) connected with the bottom-hole drilling environment (101), the one or more sensors (102) and the server (104) via the communication network (103). While drilling, it is desirable to gather as much data about the drilling process and about the formations through which the drill-bit penetrates. The bottom-hole drilling can be used with any rotary drilling, milling, subterranean reaming or drilling operations, which may be primarily used in wellbore drilling operations associated with hydrocarbon recovery, such as for Oil and gas wells.

In one embodiment, the one or more sensors (102) are configured to identify one or more real-time parameters of the bottom hole drilling environment (101), which may include parameters like fluid type (aqueous or non-aqueous mud), hole depth affecting flow pattern, real time temperature (Bottom hole circulation temperature), hydraulic diameter of the hole impacting flow path and gap, operating range including lower and upper range, annular velocity, mud composition, corrected solids percentage in the mud, emulsion density, water and oil content in the mud, oil-to-water ratio (OWR), and clay content in the mud. The one or more sensors (102) correspond to identifying the one or more parameters of bottom hole drilling conditions (101) in real-time during bore drilling. The one or more sensors (102) may comprise a bottom hole circulation temperature sensor for identifying bottom-hole temperature. In one embodiment, the bottom hole temperature may be measured by using advanced tools, available in the industry, to accurately predict the temperature value. Further, the one or more sensors (102) may comprise a sensor for calculating the annular velocity. In an exemplary embodiment, the annular velocity can be calculated by using a formula which simply divides Pump output with annular capacity. Additionally, the one or more sensors (102) may comprise a sensor for calculating a real variable identifying composition of the mud. In general, the composition of the mud is monitored and maintained by mud engineers on regular basis. Further, solid content in the mud may be calculated with the help of a Retort kit. Calculation of solid content leads to derive oil-to-water ratio in the mud. Further, clay content of the mud is maintained by material balance equation. In an embodiment of the present disclosure, the hydraulic diameter of the hole is determined by virtue of already known values of bit and drill pipe diameter. In an exemplary embodiment, if needs to drill a 12.25″ hole and the size of the drill-pipe is 5″, then hydraulic diameter of the hole can be determined by calculating (12.25−5)/2=3.625″.

In one embodiment, the network (103) may be a wireless network, a wired network, or a combination thereof. The network (103) can be implemented as one of the different types of networks such as of the different types of networks, such as an intranet, a local area network (LAN), a wide area network (WAN), an internet, and the like. The network (103) may either be a dedicated network or a shared network. The shared network represents an association of the different types of networks that use a variety of protocols, for example Hypertext Transfer Protocol (HTTP), Transmission Control Protocol/Internet Protocol (TCP/IP), Wireless Application Protocol (WAP), and the like, to communicate with one another. Further the network (103) may include a variety of network devices, namely routers, switches, bridges, servers, computing devices, storage devices, and the like.

In one embodiment, the network (103) may include any one of the following: a cable network, the wireless network, a telephone network (e.g., Analog, Digital, POTS, PSTN, ISDN, xDSL), a cellular communication network, a mobile telephone network (e.g., CDMA, GSM, NDAC, TDMA, E-TDMA, NAMPS, WCDMA, CDMA-2000, UMTS, 3G, 4G, 5G, 6G), a radio network, a television network, the Internet, the intranet, the local area network (LAN), the wide area network (WAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data. The aforementioned network (102) may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“Wi-Fi”), IEEE 802.16 (“WiMAX”), IEEE 802.20x (“Mobile-Fi”), and others.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. a critical attribute of the system (100) is that it can concurrently and instantly complete an online transaction by a system user in collaboration with other systems.

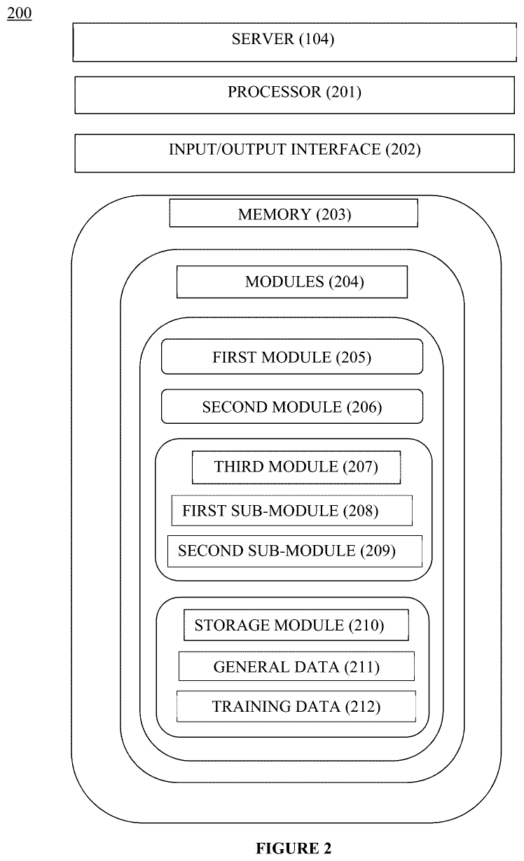

Now, referring to FIG. 2, a diagram showing an overview of a server system (200) for calculation of the shear stress at any given shear rate without using rotational viscometer data, is illustrated in accordance with an embodiment of a present subject matter. The server system (200) includes the server (104) consisting of one or more processors (201), an input-output interface (202), a memory (203). The memory (203) further includes one or more modules (204) namely, a first module (205), a second module (206), a third module (207). The third module comprises a first sub-module (208), and a second sub-module (209). The memory (203) also includes a storage module (210), which further includes a general data (211) and a training data (212).

The memory (203) in one embodiment may comprise any computer-readable medium known in the art including but not limited to volatile memory, such as static random-access memory (SRAM) and dynamic random-access memory (DRAM), and/or non-volatile memory, such as read-only memory (ROM), solid state memory, erasable programmable ROM, flash memories, hard disks, optical disks, memory cards, virtual memory and distributed cloud storage. The memory (203) may be removable, non-removable, or a combination thereof. Further, the server (104) includes the one or more processors (201) that read data from various entities such as memory (203) or I/O interface (202). In one embodiment the one or more processers (201) is coupled to the memory (203) and is configured to execute programmed instructions stored in the memory (203). The one or more processor (201), in one embodiment, may comprise a standard microprocessor, microcontroller, central processing unit (CPU), distributed or cloud processing unit, and/or other processing logic that accommodates the requirements of the present invention. The I/O interface (202) allow the server (104) to be logically coupled to other devices namely the one or more I/O components (105, 106), some of which may be built in. Illustrative components include tablets, mobile phones, scanner, printer, wireless device, etc.

In one implementation of the present disclosure, the memory (203) further comprises one or more modules (204). The one or more modules (204) may include one or more instructions, executed by the processor (201), for calculation of the shear stress at any given shear rate without using rotational viscometer data. The one or more module (204) comprises a first module (205) configured to calculate one or more data constants. The one or more data constants corresponds to represent one of size and shape of cutting, tortuosity of the hole, lubricity of a fluid, fanning friction factor, period of static state of mud during operation and a combination thereof. The lubricity of the fluid has an impact on shear stress but the same cannot be quantified due to lubricity changes in oil to water ratio and also with the type of base oil. There are hundreds of different types of base oil in use, making the lubricity values too fictitious. Further, presence of cuttings also impacts the shear stress values but the exact size/shape of cuttings cannot be quantified. Further, tortuosity of the hole also affects the shear stress of mud and the same cannot be precisely quantified. Further, fanning friction factor, period of static state of mud during operation/s also has impact on shear stress of mud that cannot be accurately measured and incorporated as a known variable. To minimize/eliminate the impact of these variables, one or more data constants have been introduced in the calculation which more or less represents the anticipated impact of these variables and thus, error's magnitude has been marginalized to quite an extent. In one embodiment, one or more data constants correspond to an aqueous constant for calculating shear stress of aqueous mud. In another embodiment, the one or more data constants correspond to non-aqueous constant for calculating shear stress of non-aqueous mud. In an exemplary embodiment, for the aqueous mud, the aqueous constant is determined using a formula involving parameters like hydraulic diameter, solids content, clay content, annular velocity, bottom hole circulating temperature, oil percentage, and corrected solids. Similarly, for the non-aqueous mud, the non-aqueous constant is calculated using a formula incorporating factors like hydraulic diameter, corrected solids, emulsion density, water percentage, clay content, annular velocity, bottom hole circulating temperature, oil percentage, and the oil-to-water ratio.

The one or more module (204) comprises a second module (206) for selecting a shear rate. The shear rate may also vary at different RPM values, potentially including 600 RPM, 300 RPM, 200 RPM, 100 RPM, 60 RPM, 30 RPM, 6 RPM, and 3 RPM. The selected RPMs are same as being used in the industry since inception. All this collected data is stored and processed by the server (104).

Furthermore, in another embodiment, one or more module (204) comprises a third module (207) for calculating the shear stress for the selected shear rate by using the one or more data constants and the one or more parameters of bottom hole drilling conditions identified by the one or more sensors (102). In one embodiment, the third module (207) comprise a first sub-module (208) for calculating the shear stress for the aqueous mud. In another embodiment, the third module (207) comprise a second sub-module (208) for calculating the shear stress for the non-aqueous mud. In one embodiment for aqueous mud, the first sub-module (208) is configured to receive the aqueous constant, calculated by the first module (205). In an exemplary embodiment, the aqueous constant, is calculated by the first module (205) by using a formula:

$$Aqueous constant = 7687.872 * {( Hydraulic diameter )}^{1 / 2} * corrected solids * {( clay content )}^{1 / 2} / Annular velocity * Bottom hole circulation temperature * ( 100 - oil percentage + ( corrected solids ) )$$

In a related exemplary embodiment for aqueous mud, the first sub-module (208) is configured calculate the shear stress for the aqueous mud by using a formula:

$$Shear stress ( Aqueous Mud ) = 4.51881 * {( Aqueous constant )}^{1.000799} * {( shear rate )}^{0.67483}$$

In another exemplary embodiment for non-aqueous mud, the second sub-module (208) is configured to receive the non-aqueous constant, calculated by the first module (205). In an exemplary embodiment, the non-aqueous constant, is calculated by the first module (205) by using a formula:

$$Non - aqueous constant = ( 1.362 * {( hydraulic diameter )}^{1 / 2} * corrected solids * emulsion density * water percentage * clay content / Annular velocity * Bottom Hole Circulation Temperature * Oil percentage * {( oil percentage / water percentage )}^{1 / 2}$$

In a related exemplary embodiment for non-aqueous mud, the second sub-module (208) is configured calculate the shear stress for the non-aqueous mud by using a formula:

$$Shear stress ( Non - aqueous Mud ) = 8.336 * {( non - aqueous constant )}^{1.0021} * {( shear rate )}^{0.6942}$$

While the formula was under evolvement, it was realized that although these variables affect the shear stress, but their weightages of impact differ on shear stress. For example, although the solid content of mud and the bottom hole circulating temperature, both impact the shear stress of mud, but their magnitude is different and hence, a suitable weightage has to be proportionately and justifiably given to each variant to make the final calculation as precise as realistically possible. Another factor that attracted equal attention was the exact numerical value of each variable vis-a-vis the degree of impact it has on final value of shear stress. A regression treatment was offered accordingly to ensure that each variable gets its proportional and justified inclusion. For example, although the numerical value of hydraulic diameter of the hole is smaller in comparison of emulsion density, but the hydraulic diameter impacts shear stress more profoundly than emulsion density and this was addressed by applying correct regression to bring the numerical value in the range of its actual impact. The parameters that increase shear stress with their increasing values were grouped together as denominator and the factors that decrease shear stress with increase in their numerical value were placed at numerator.

In one embodiment of the present disclosure, the third module (207) including the first sub-module (208) and the second sub-module (209) are implemented using artificial intelligence (AI) enabled multi-variate linear regression model. The AI enabled model has capability to calculate shear stress of the mud at any shear rates, which traditionally was not possible due to limitation of the instrument. Further, the AI enabled model trained over a large set of sample data which give rise to accurate predictions of shear stress/shear rate relationship under various permutation/combinations of all the variables. Further, the AI enabled model improves over time, which optimize its output based on learnings from the various factors affecting the shear stress in real time bottom hole environment,

In another embodiment, the server system (200) may also employ a storage module (210) which may include a general data (211), and a training data (212). Further, the general data (211) may include the conventional data received by the system (100) namely the non-quantifiable parameters of data constants calculated by the first module (205), or the different values of shear rates selected by the second module (206). Moreover, the training data (212) may include the real-time bottom-hole conditions (101) identified by the one or more sensors (102). The storage module may further be equated with a multivariate linear regression model within the third module (207) for more advanced analysis. Further, the third module (207) is configured to calculate the shear stress for the aqueous and the non-aqueous mud separately using the multivariate linear regression model.

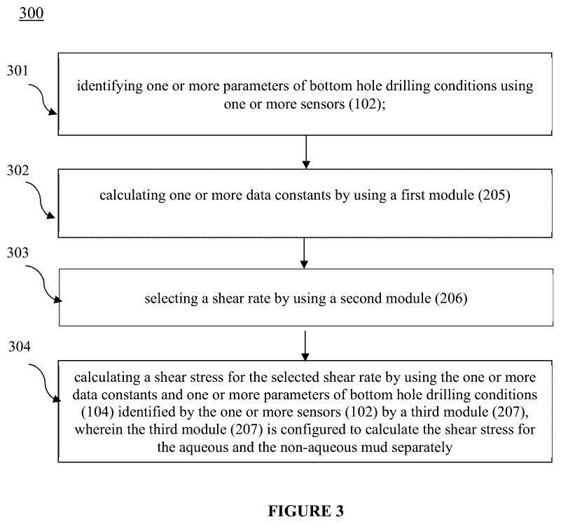

Now referring to FIG. 3, a flowchart describing a method (300) for calculating the shear stress at any given shear rate without using rotational viscometer data, is illustrated in accordance with an embodiment of the present subject matter. The method (300) includes calculation of the shear stress under bottom hole drilling environment (101) for both an aqueous and a non-aqueous mud. The method (300) involves multiple stages. Initially at step (301), bottom hole drilling condition parameters are detected using one or more sensors (102). Subsequently at step (302), a first module (205) may be used to calculate one or more data constants, while, at step (303), a second module (206) may be used to selects a shear rate. Further, at step (304), a third module (207) utilizes the received data constants and identified drilling condition parameters to calculate shear stress separately for the aqueous and the non-aqueous mud.

In another non-limiting embodiment, the method (300) includes a utilization of one or more sensors (102) to continuously identify (301) real-time bottom hole drilling conditions (101). These conditions may encompass a broad spectrum of parameters, namely fluid type, hole depth affecting flow patterns, temperature variations, hole diameter impacting flow paths and gaps, operational ranges, annular velocity, mud composition, solids percentage, emulsion density, water and oil content, oil-to-water ratio, and clay content. Additionally, the method (300) may incorporate specific data constants to address non-quantifiable parameters such as cutting size and shape, hole tortuosity, fluid lubricity, fanning friction factor, and the duration of static states during drilling operations. The shear rate in the method (300) may also vary across a range of RPM values, potentially including 600 RPM, 300 RPM, 200 RPM, 100 RPM, 60 RPM, 30 RPM, 6 RPM, and 3 RPM.

In one embodiment, the method (300) includes the third module (207), consisting of two distinct sub-modules, namely a first sub-module (208) and a second sub-module (209) dedicated to calculating shear stress in both the aqueous and the non-aqueous mud. These calculations are underpinned by specific formula constants tailored for each mud type. For the aqueous mud, the data constant is computed using a first formula incorporating hydraulic diameter, solids content, clay content, annular velocity, bottom hole circulating temperature, oil percentage, and corrected solids. The shear stress in the aqueous mud is subsequently determined using a second formula. Similarly, for the non-aqueous mud, a unique data constant is derived using a third formula that factors in hydraulic diameter, corrected solids, emulsion density, water percentage, clay content, annular velocity, bottom hole circulating temperature, oil percentage, and the oil-to-water ratio. The shear stress for the non-aqueous mud is then calculated using a respective fourth formula. As a culmination of the process, the method (300) may employ a multivariate linear regression model within the third module (207) to enable more advanced analysis of drilling conditions and mud rheology.

In an exemplary embodiment, the method (300) as disclosed includes the third module (207) which corresponds to a first sub-module (208) and a second sub-module (209), wherein the first sub-module (208) is configured to calculate the shear stress for the aqueous mud, and the second sub-module (209) is configured to calculate the shear stress for the non-aqueous mud.

The system (100) as disclosed in the present disclosure offers significant advantages over traditional rotational viscometers commonly used in drilling operations. Firstly, it eliminates the memory retention issue inherent in viscometers, where prior fluid properties influence subsequent measurements. This ensures more accurate real-time rheological data, particularly crucial when transitioning between fluids of varying thickness. Additionally, the system (100) effectively addresses the anomalous temperature behaviour of drilling fluids. Unlike aqueous mud, non-aqueous mud experiences exponential rheology reduction with increasing temperature, a critical distinction often overlooked by rotational viscometers. Moreover, the system (100), by eliminating need of measuring equipment, minimizes measurement and calibration errors associated with reading scales and equipment calibration, reducing uncertainty in data quality.

Further, the system (100) enables re-visit practice of measuring the plastic viscosity and/or yield point altogether by better property or by reconsidering the shear rate values used for measuring the desired rheological properties. Further, the system enables to have values more relevant for bottom-hole conditions of drilling. Further, the system (100) allows to have the flexibility of managing rheology that is specific to the type of mud system and the formula is tailor-made for each mud system. Further, field management of drilling fluids will become more convenient as the field engineer need not spend his time on measuring the rheology and instead, focus on managing fluids better by calculating with the help of software. Further, the precise behaviour of mud will be available for shear rate more than 600 RPM also. Furthermore, the results are completely free form personal measurement related bias as well as the limitation of equipment in terms of reproducibility as well as accuracy of the results.

Furthermore, the system (100) considers the discrepancy between the actual fluid flow in the borehole and the circular motion simulated by equipment, enhancing measurement realism. This system also departs from the industry's convention of fixed RPM measurements, offering flexibility to calculate shear stress at various shear rates. It overcomes design limitations present in some equipment and accounts for variations in hydraulic diameter, which is common during drilling. Finally, it aligns measurement patterns with real-world conditions, capturing shear rate variations from low to high, a feature lacking in traditional methods. Overall, this system promises more accurate, versatile, and operationally relevant rheological data for improved drilling fluid management.

The embodiments, examples and alternatives of the preceding paragraphs or the description and drawings, including any of their various aspects or respective individual features, may be taken independently or in any combination. Features described in connection with one embodiment are applicable to all embodiments unless such features are incompatible.

The foregoing description shall be interpreted as illustrative and not in any limiting sense. A person of ordinary skill in the art would understand that certain modifications could come within the scope of this disclosure. The embodiments, examples and alternatives of the preceding paragraphs or the description and drawings, including any of their various aspects or respective individual features, may be taken independently or in any combination. Features described in connection with one embodiment are applicable to all embodiments unless such features are incompatible.

Although the implementations for system (100) calculating of a shear stress at any given shear rate for an aqueous and a non-aqueous mud separately at bottom hole drilling conditions (101) without using rotational viscometer data, have been described in language specific to structural features and/or methods, it is to be understood that the appended claims are not necessarily limited to the specific features or methods described. Rather, the specific features and methods are disclosed as examples of implementations for the shear stress calculation system.

1. A system for calculating a shear stress at any given shear rate for an aqueous and a non-aqueous mud separately at bottom hole drilling conditions without using rotational viscometer data, characterized in that, the system comprises:
a. one or more sensors to identify one or more parameters of bottom hole drilling conditions;
b. a first module for calculating one or more data constants;
c. a second module for selecting a shear rate; and
d. a third module for calculating the shear stress for the selected shear rate by using the one or more data constants and the one or more parameters of bottom hole drilling conditions identified by the one or more sensors, wherein the third module is configured to calculate the shear stress for the aqueous and the non-aqueous mud separately.

2. The system as claimed in claim 1, wherein the one or more sensors corresponds to identifying the one or more parameters of bottom hole drilling conditions in real-time during bore drilling.

3. The system as claimed in claim 1, wherein the one or more parameters of bottom hole drilling conditions corresponds to one of type of fluid (aqueous or non-aqueous mud), depth of a hole to address flow pattern, real-time temperature (Bottom hole circulation temperature), Hydraulic diameter of the hole to cater to the flow path, operating range including lower and upper range, annular velocity, composition of mud, corrected solids (solids percentage in mud), emulsion density, water percentage, oil percentage, OWR (oil/water ratio), clay content of mud, and a combination thereof.

4. The system as claimed in claim 1, wherein the one or more data constants correspond to one of size and shape of cutting, tortuosity of the hole, lubricity of a fluid, fanning friction factor, period of static state of mud during operations, and a combination thereof.

5. The system as claimed in claim 1, wherein the shear rate corresponds to different values of RPM (revolution per minute), namely 600 RPM, 300 RPM, 200 RPM, 100 RPM, 60 RPM, 30 RPM, 6 RPM and 3 RPM.

6. The system as claimed in claim 1, wherein the third module comprises a first sub-module and a second sub-module, wherein the first sub-module is configured to calculate the shear stress for the aqueous mud, and the second sub-module is configured to calculate the shear stress for the non-aqueous mud, wherein the third module corresponds to a multivariate linear regression model using machine learning technology.

7. The system as claimed in claim 6, wherein the first sub-module is configured to receive an aqueous constant, calculated by the first module, by using:
$$Aqueous constant = 7687.872 * {( Hydraulic diameter )}^{1 / 2} * corrected solids * {( clay content )}^{1 / 2} / Annular velocity * Bottom hole circulation temperature * ( 100 - oil percentage + ( corrected solids ) ) .$$

8. The system as claimed in claim 7, wherein the first sub-module is configured to calculate the shear stress for the aqueous mud by using:
$$Shear stress ( Aqueous Mud ) = 4.51881 * {( Aqueous constant )}^{1.000799} * {( shear rate )}^{0.67483} .$$

9. The system as claimed in claim 6, wherein the second sub-module is configured to receive non-aqueous constant, calculated by the first module, by using:
$$Non - aqueous constant = ( 1.362 * {( hydraulic diameter )}^{1 / 2} * corrected solids * emulsion density * water percentage * clay content / Annular velocity * Bottom Hole Circulation Temperature * Oil percentage * {( oil percentage / water percentage )}^{1 / 2} .$$

10. The system as claimed in claim 9, wherein the second sub-module is configured to calculate the shear stress for the non-aqueous mud by using:
$$Shear stress ( Non - aqueous Mud ) = 8.336 * {( non - aqueous constant )}^{1.0021} * {( shear rate )}^{0.6942} .$$

11. A method for calculation of a shear stress at any given shear rate for an aqueous and a non-aqueous mud separately at bottom hole conditions without using rotational viscometer data, characterized in that, the method comprises:
a. identifying one or more parameters of bottom hole drilling conditions using one or more sensors;
b. calculating one or more data constants by using a first module;
c. selecting a shear rate by using a second module; and
d. calculating a shear stress for the selected shear rate by using the one or more data constants and one or more parameters of bottom hole drilling conditions identified by the one or more sensors by a third module, wherein the third module is configured to calculate the shear stress for the aqueous and the non-aqueous mud separately.

12. The method as claimed in claim 11, wherein the identification of the one or more parameters of bottom hole drilling conditions is performed in real-time during bore drilling.

13. The method as claimed in claim 11, wherein the one or more parameters of bottom hole drilling conditions corresponds to one of type of fluid (aqueous or non-aqueous mud), depth of a hole to address flow pattern, real-time temperature (Bottom hole circulation temperature), Hydraulic diameter of the hole to cater flow path and gap, operating range including lower and upper range, annular velocity, composition of mud, corrected solids (solids percentage in mud), emulsion density, water percentage, oil percentage, OWR (oil/water ratio), clay content of mud, and a combination thereof.

14. The method as claimed in claim 11, wherein the one or more data constants corresponds to one of size and shape of cutting, tortuosity of the hole, lubricity of a fluid, fanning friction factor, period of static state of mud during operations, and a combination thereof.

15. The method as claimed in claim 11, wherein the selection of the shear rate corresponds to different values of RPM (revolution per minute), namely 600 RPM, 300 RPM, 200 RPM, 100 RPM, 60 RPM, 30 RPM, 6 RPM and 3 RPM.

16. The method as claimed in claim 11, wherein the third module comprises a first sub-module and a second sub-module, wherein the first sub-module is configured to calculate the shear stress for the aqueous mud, and the second sub-module is configured to calculate the shear stress for the non-aqueous mud, wherein the third module corresponds to a multivariate linear regression model using machine learning technology.

17. The method as claimed in claim 16, wherein the first sub-module is configured to receive an aqueous constant, calculated by the first module, by using:
$$Aqueous constant = 7687.872 * {( Hydraulic diameter )}^{1 / 2} * corrected solids * {( clay content )}^{1 / 2} / Annular velocity * Bottom hole circulation temperature * ( 100 - oil percentage + ( corrected solids ) ) .$$

18. The method as claimed in claim 17, wherein the first sub-module is configured to calculate the shear stress for the aqueous mud by using:
$$Shear stress ( Aqueous Mud ) = 4.51881 * {( Aqueous constant )}^{1.000799} * {( shear rate )}^{0.67483} .$$

19. The method as claimed in claim 16, wherein the second sub-module is configured to receive non-aqueous constant, calculated by the first module by using:
$$Non - aqueous constant = ( 1.362 * {( hydraulic diameter )}^{1 / 2} * corrected solids * emulsion density * water percentage * clay content / Annular velocity * Bottom Hole Circulation Temperature * Oil Percentage * {( oil percentage / water percentage )}^{1 / 2} .$$

20. The method as claimed in claim 19, wherein the second sub-module is configured to calculate the shear stress for the non-aqueous mud by using:
$$Shear stress ( Non - aqueous Mud ) = 8.336 * {( non - aqueous constant )}^{1.0021} * {( shear rate )}^{0.6942} .$$
